(19) United States
(12) Patent Application Publication
(10) Pub. No.: US 2012/0117259 A1
(43) Pub. Date: May 10, 2012

(54) DEVICES, SYSTEMS AND METHODS OF SETTING MACHINES

(76) Inventors: Yu Fan LIN, Taipei City (TW); Ping Hui Lu, Sanchong City (TW); Chang Yi Kao, Taipei City (TW)

(21) Appl. No.: 12/974,368

(22) Filed: Dec. 21, 2010

(30) Foreign Application Priority Data
Nov. 10, 2010 (TW) 99138627

(51) Int. Cl. G06F 15/16

(52) U.S. Cl. 709/229

(57) ABSTRACT

A machine setting device connected to a first machine, including a machine communicate unit, receiving a first machine signal of the first machine; a signal transform unit, transforming the first machine signal into a machine analysis signal with a normal format according to a normal communicate interface; a storage unit, storing an authentication data; and a processor, a processor, authenticating the first machine according to the authentication data and the machine analysis signal, and generating an authentication success signal if authentication is successful, wherein the machine communicate unit sends a machine return signal to the first machine according to the authentication success signal.

### CROSS REFERENCE TO RELATED APPLICATIONS

This application claims priority of Taiwan Patent Application No. 99138627, filed on Nov. 10, 2010, the entirety of which is incorporated by reference herein.

### BACKGROUND OF THE INVENTION

1. Field of the Invention

The disclosure relates generally to methods and devices for setting machines, and more particularly relates to methods and devices for easily setting and processing authentication self-help machines.

2. Description of the Related Art

Conventional self-help machines (e.g., a vending machine, coin operated washing machine, game machine, toy crane machine, ticket machine, KiOSK, Digital Signage, etc.) are operable by a programmable logic controller (PLC board), communicating with the others by a serial port without a plug and play (PnP) mechanism. Some electric equipment provide plug and play (PnP) mechanisms, but it must be a Universal Plug and Play (UPnP) mechanisms which is not applied in conventional self-help machines. For business purposes, the position of self-help machines are usually moved or changed, and settings thereof are changed by accessing information from a remote server or other self-help machines is desired. However, it is not convenient to manually change the setting of the self-help machine in the conventional art. Meanwhile, conventional self-help machines lack an authentication mechanism, thus, making them venerable to theft.

Furthermore, there are many types of self-help machines, having various ways of transmission (e.g., analog, series port, open systems interconnect, etc.). Thus, it is not easy for an owner to manage or integrate different self-help machines together, which increases costs.

### BRIEF SUMMARY OF THE INVENTION

For solving the above problems, the invention provides a machine authentication device and method for quickly processing authentication and settings. The invention further integrates machines with various ways of transmission to simplify data access between machines.

In an embodiment of a machine setting device connected to a first machine, the machine setting device comprises: a machine communicate unit, receiving a first machine signal of the first machine; a signal transform unit, transforming the first machine signal into a machine analysis signal with a normal format according to a normal communicate interface; a storage unit, storing authentication data; and a processor, authenticating the first machine according to the authentication data and the machine analysis signal, and generating an authentication success signal if authentication is successful, wherein the machine communicate unit sends a machine return signal to the first machine according to the authentication success signal.

In an embodiment of a machine setting system, the machine setting system comprises: a first machine, outputting a first signal; a composite machine authentication device connected to the first machine for receiving the first machine signal, authenticating the first machine according authentication data and the first machine signal, by generating authentication success information if authentication is successful, and sending a first machine return signal to the first machine according to the authentication success information; and a remote platform connected to the composite machine authentication device through a communication network, sending the authentication data to the composite machine authentication device.

In an embodiment of a method for setting machines performed by an electronic device connected to a first machine, the method comprises: receiving a first machine signal of the first machine; transforming the first machine signal into a machine analysis signal with a normal format according to a normal communicate interface; authenticating the first machine according to authentication data and the machine analysis signal; outputting an authentication success signal if authentication is successful; and sending a first machine return signal to the first machine according to the authentication success signal.

### BRIEF DESCRIPTION OF DRAWINGS

The invention will become more fully understood by referring to the following detailed description with reference to the accompanying drawings, wherein:

FIG. 1 is a schematic diagram illustrating an embodiment of a machine setting device 100;

FIG. 2 is a schematic diagram illustrating an embodiment of a machine setting system 200;

FIG. 3 is a flowchart of an embodiment of a method for the machine setting device 100 shown in FIG. 1;

FIG. 4a is a flowchart of an embodiment of a method for the step S310 shown in FIG. 3;

FIG. 4b is a flowchart of another embodiment of a method for the step S310 shown in FIG. 3; and

FIG. 4c is a flowchart of another embodiment of a method for the step S310 shown in FIG. 3.

### DETAILED DESCRIPTION OF THE INVENTION

The making and using of the embodiments of the present invention are discussed in detail below. It should be appreciated, however, that the embodiments provide many applicable inventive concepts that can be embodied in a wide variety of specific contexts. The specific embodiments discussed are merely illustrative of specific ways to make and use the invention, and do not limit the scope of the invention.

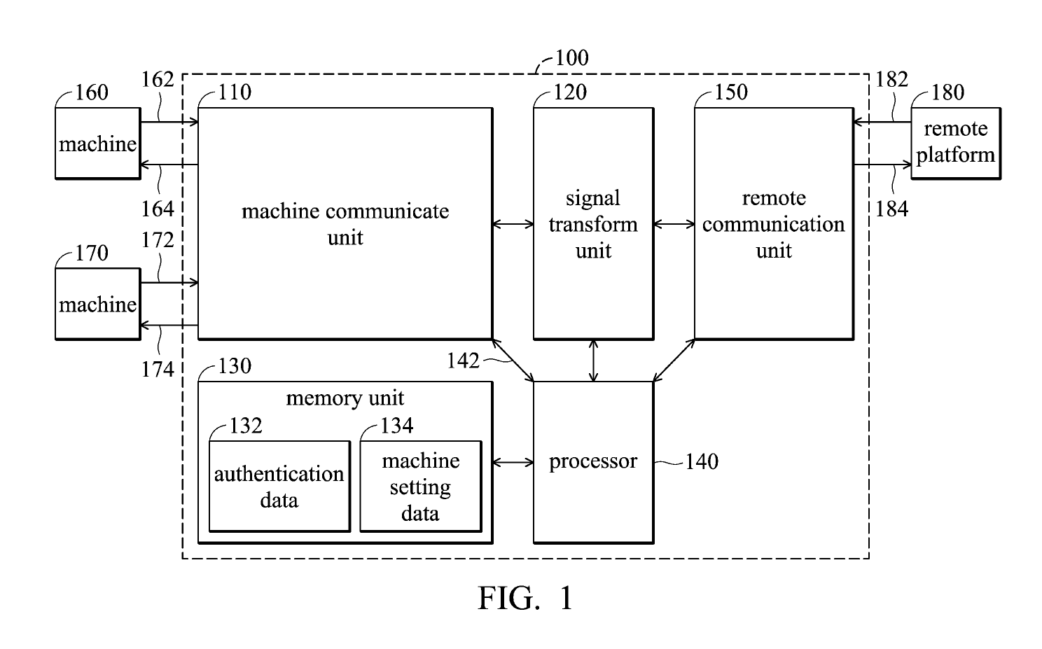

FIG. 1 is a schematic diagram illustrating an embodiment of a machine setting device 100. The machine setting device 100 comprises a machine communicate unit 110, a signal transform unit 120, a storage unit 130, and a processor 140. In the illustrated embodiment, the machine communicate unit 110 receives a machine signal 162 of a machine 160 and sends a machine return signal 164 to the machine 160. The signal transform unit 120 transforms the machine signal 162 into a machine analysis signal with a normal format (e.g., XML) according to a normal communicate interface. The processor 140 sends an authentication success signal 142 to the machine 160 for determining the machine return signal 164 according authentication data 132 stored in the storage unit 130 and the machine signal 162, wherein the authentication data 132 may be machine ID, identity code or any data which can be used for authentication. The machine setting device 100 may be formed in a box or a dedicated machine, or performed by a computer, industrial computer, sever or any machine with computing capability.

In the illustrated embodiment, in order to process a setting machine, the storage unit 130 further stores composite machine setting data 134 and the machine communicate unit 110 sends a machine return signal 164 to the machine 160 according to the composite machine setting data 134. The composite machine setting data 134 may include any information related to a connected machine such as a model number, configuration value, location, machine code, data format, transmission type, control instruction, or monitor information. In some illustrated embodiments, the composite machine setting data 134 can also include the authentication data 132.

In the illustrated embodiment, the machine communicate unit 110 further receives a machine signal 172 of a machine 170 and sends a machine return signal 174 to the machine 170. Thus, the machine 160 can access the data of the machine 170 after the machine 160 is successfully authenticated. For example, the machine 160 sends the machine signal 162 to the machine setting device 100 to request access to data of the machine 170. Next, the machine communicate unit 110 receives the machine signal 172, the processor 140 generates the composite machine setting data 134 according to the machine signal 172, and the machine communicate unit 110 sends the machine return signal 164 to the machine 160 according to the composite machine setting data 134. Thus, the machine 160 can access the data of the machine 170.

Note that different machines have different communication protocol or transport levels. To solve this, the machine setting device 100 applies to various ways of transmission. In some embodiments, each machine connected to the machine setting device 100 can communicate with each other easily, the signal transform unit 120 can transform arbitrary machine signal (e.g., the machine signal 172) into the machine analysis signal with a normal format according to a normal communicate interface. In some embodiments of the invention, in order to make communication more reliable and convenient for users to manage, each machine analysis signal can be transformed into a normal communication language interface such as an XML interface.

In some embodiments of the invention, the machine setting device 100 further includes a remote communication unit 150 receiving a remote platform signal 182 of a remote platform 180, and the processor 140 generates the composite machine setting data 134 according to the remote platform signal 182. In the illustrated embodiment, the machine setting device 100 connects to the remote platform 180 through a communication network. The processor 140 updates the authentication data 132 stored in the storage unit 130 by the remote platform signal 182 for processing authentication of the machine. The authentication data 132 can be updated when a machine connects to the machine setting device 100 and processes authentication in real time by accessing the information of the remote platform signal 182. In another embodiment of the invention, the authentication data 132 is updated periodically by the remote platform 180 and stored in the storage unit 130, so that when arbitrary machine connects to the machine setting device 100, authentication can be immediately processed according to the authentication data 132 without waiting for new authentication data to be received from the remote platform 180.

In some embodiments of the invention, in order to easily manage the remote machine, the remote platform 180 can further access data of a machine connected to the machine setting device 100. For example, when the remote platform 180 tries to access the data of the machine 160, the remote platform 180 sends the remote platform signal 182 to the remote communication unit 150 to request to access the data of the machine 160, wherein the processor 140 generates the composite machine setting data 134 according to the machine signal 162 received by the machine communicate unit 110, and then the remote communication unit 150 sends a remote platform return signal 182 to the remote platform 180 according to the composite machine setting data 134.

In some embodiments of the invention, the machine communicate unit 110 can further send a test signal to arbitrary machine, and determine whether to accept the machine signal according a test response signal from the machine in order to perform a “plug and play” function. Thus, the machine setting device 100 can detect if arbitrary machine is connected to the machine setting device 100.

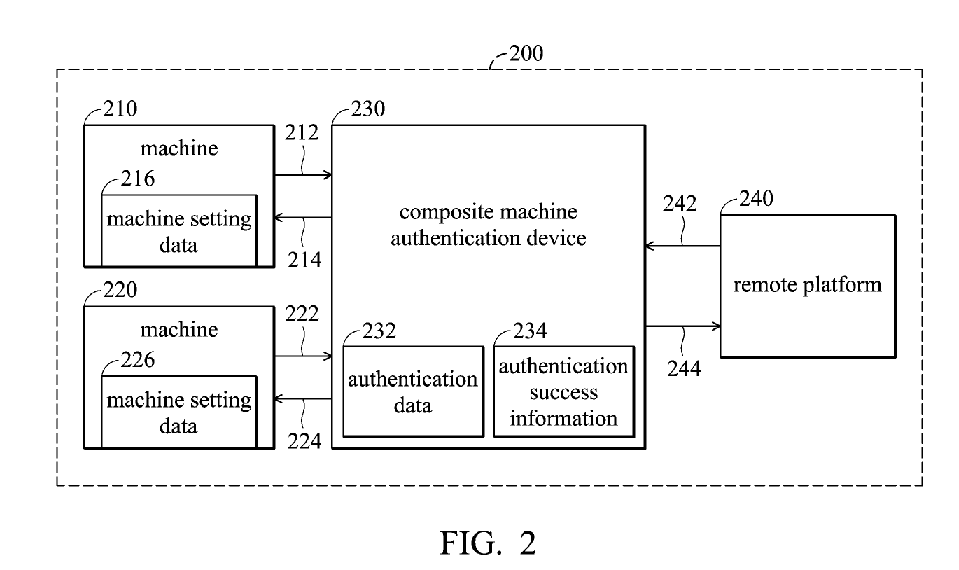

FIG. 2 is a schematic diagram illustrating an embodiment of a machine setting system 200. As shown in FIG. 2, the machine setting system 200 comprises a machine 210, a machine 220, a composite machine authentication device 230, and a remote platform 240. In some embodiments, the machine 210 and the machine 220 are connected to the composite machine authentication device 230, and the composite machine authentication device 230 is connected to the remote platform 240.

In some embodiments of the invention, the machine setting system 200 further provides an authentication mechanism to authenticate machines. For example, the machine 210 outputs a machine signal 212 to the composite machine authentication device 230 for authentication when the machine 210 is connected to the composite machine authentication device 230, wherein the composite machine authentication device 230 processes authentication according to authentication data 202 and the machine signal 212. The composite machine authentication device 230 generates authentication success information 234 if the authentication is successful. After that, the composite machine authentication device 230 sends a machine return signal 214 to the machine 210 according to the authentication success information 234 for finishing the authentication of the machine 210. In some embodiments of the invention, the machine 210 authentication must be successful before the machine 210 can access the data of the other machine in the system or process settings to the machine 210.

In some embodiments of the invention, the authentication data 202 is provided by the remote platform 240. The remote platform 240 can update the authentication data 232 stored in the composite machine authentication device 230 periodically. In some embodiments of the invention, the composite machine authentication device 230 can send a remote platform return signal 244 to the remote platform 240 for the authentication data 232 when arbitrary machine needs authentication. In another embodiment of the invention, the composite machine authentication device 230 can further send the authentication request to the remote platform 240 via the remote platform return signal 244, and process authentication in the remote platform 240. In this embodiment, the remote platform 240 may not need to send the authentication data 232 to the composite machine authentication device 230 for storage.

In some embodiments of the invention, in order to process setting of the remote machine, the remote platform 240 can further send a remote platform signal 242 to the composite machine authentication device 230, and the composite machine authentication device 230 would generate composite machine setting data. Thus, the composite machine authentication device 230 generates a machine return signal 214 to process setting machine 210 according to the composite machine setting data.

In some embodiments of the invention, the machine 210 has machine setting data 216 (e.g., machine ID, machine location, machine configuration, machine status or any information relating to the machine). When the remote platform 240 tries to access the machine setting data 216, the remote platform 240 sends the remote platform signal 242 to the composite machine authentication device 230 to request to access the machine setting data 216. Next, the composite machine authentication device 230 sends the machine return signal 214 to the machine 210 to request to access the machine setting data 216, wherein the machine 210 provides the machine setting data 216 to the composite machine authentication device 230 via the machine signal 212, and the composite machine authentication device 230 provides the machine setting data 216 to the remote platform 240 via the remote platform return signal 244. Thus, the remote platform 240 can collect the machine setting data of each machine to gather statistics and manage the machines connected to the composite machine authentication device 230, therefore, being more convenient for users to monitor the status of each machine.

In some embodiments of the invention, the machine 220 has machine setting data 226. When the machine 210 tries to access the machine setting data 226, the machine 210 sends the machine signal 212 to the composite machine authentication device 230 to request to access the machine setting data 226. Next, the composite machine authentication device 230 sends the machine return signal 224 to the machine 220 to request to access the machine setting data 226, wherein the machine 220 provides the machine setting data 226 to the composite machine authentication device 230 via the machine signal 222, and the composite machine authentication device 230 provides the machine setting data 226 to the machine 210 via the machine return signal 214. Thus, it may be applied to a plurality of machines, wherein each machine may access the data of others, and further provides an advanced operation, such as a tie-in sale.

The composite machine authentication device 230 is applied with various ways of transmission due to different machines having different communications protocol or transport levels. In some embodiments of the invention, the composite machine authentication device 230 transforms each machine signal into a normal format signal according to a normal communicate interface, so that the machines can communicate with each other easily.

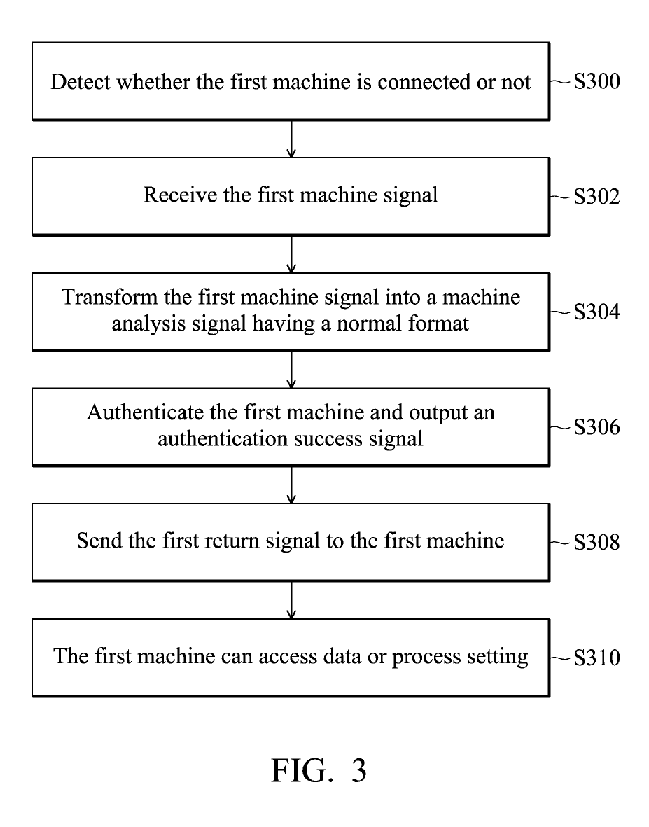

FIG. 3 is a flowchart of an embodiment of a method for the machine setting device 100 shown in FIG. 1. In step S300, the machine setting device detects whether the first machine is connected thereto or not. In some embodiments of the invention, the machine setting device 100 sends a test signal to the machine 160, and determines whether to accept the machine signal according a test response signal from the machine 160 in order to perform a “plug and play” function. Thus, the machine setting device 100 can detect whether the machine 160 is connected the machine setting device 100 or not. In step S302, the machine setting device 100 receives the machine signal 162 of the machine 160.

In step S304, the machine setting device transforms the machine signal into a machine analysis signal with a normal form. Thus, it is convenient to integrate different machines having different communicate interface due to the signal of the machines being in a normal form.

In step S306, the machine setting device 100 authenticates the machine 160 according to the authentication data 132 and the machine analysis signal transformed from machine signal 162, and outputs the authentication success signal 142 to the machine communicate unit 110. In some embodiments of the invention, step S304 may be skipped and the machine signal 162 may be directly authenticated without transforming the machine signal 162 into a normal form. In some embodiments of the invention, the process will stop if authentication of the machine is not successful.

In step S308, the machine setting device 100 generates the machine return signal 164 according to the authentication success signal 142 and sends the machine return signal 164 to the machine 160 to enable the machine 160 to work in the system. In step S310, the machine 160 begins to access data or configure settings.

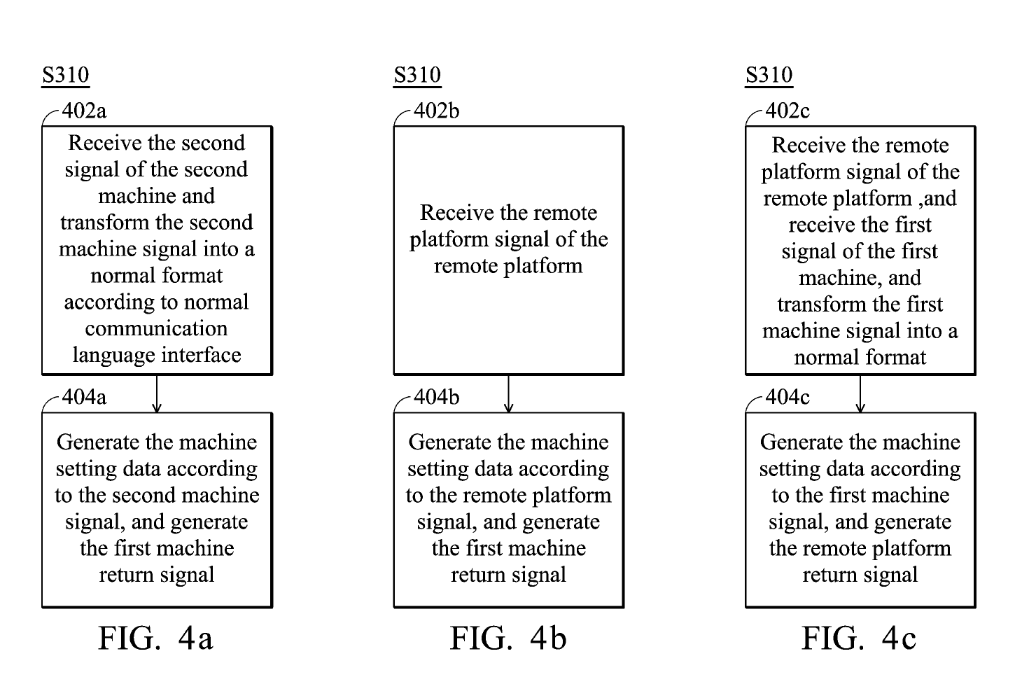

FIG. 4a is a flowchart of an embodiment of a method for the step S310 shown in FIG. 3. In some embodiments of the invention, for the machine 160 to access the data of the machine 170, at step S402a, the machine setting device 100 receives the machine signal 172 of the machine 170 according to the machine analysis signal transformed from machine signal 162. In step S404a, the machine setting device 100 generates the composite machine setting data 134 and generates the machine return signal 164 according to the composite machine setting data 134. Thus, the machine 160 accesses the data of the machine 170 by receiving the machine return signal 164, and processes settings or applications according to the information of the machine return signal 164.

FIG. 4b is a flowchart of another embodiment of a method for the step S310 shown in FIG. 3. In this embodiment of the invention, users can set the machine 160 by a remote server. At step S402b, the machine setting device 100 receives the remote platform signal 182 of the remote platform 180. In step S404b, the machine setting device 100 generates the composite machine setting data 134 according to the remote platform signal 182 and generates the machine return signal 164 according to the composite machine setting data 134. Thus, the remote platform 180 can change the date or configuration of the machine 160.

FIG. 4c is a flowchart of another embodiment of a method for the step S310 shown in FIG. 3. In this embodiment of the invention, for the remote platform 180 to access the data of the machine 160, at step S402c, the machine setting device 100 receives the machine signal 162 of the machine 160 according to the remote platform signal 182 of the remote platform 180. In step S404c, the machine setting device 100 generates the composite machine setting data 134 and generates the remote platform return signal 184 according to the composite machine setting data 134. Thus, the remote platform 180 accesses the data of the machine 160 by the remote platform return signal 184. Also, the remote platform 180 can access the data of the machine 170.

While the invention has been described by way of example and in terms of preferred embodiment, it is to be understood that the invention is not limited thereto. Those who are skilled in this technology can still make various alterations and modifications without departing from the scope and spirit of this invention. For example, the remote platform can connect to a plurality of machine setting devices, and a machine setting device can also connect to a plurality of machines. Therefore, the scope of the present invention shall be defined and protected by the following claims and their equivalents.

What is claimed is:

1. A machine setting device connected to a first machine, comprising:
a machine communicate unit, receiving a first machine signal of the first machine;
a signal transform unit, transforming the first machine signal into a machine analysis signal with a normal format according to a normal communicate interface;
a storage unit, storing an authentication data; and
a processor, authenticating the first machine according to the authentication data and the machine analysis signal, and generating an authentication success signal if authentication is successful for authenticating the first machine,
wherein the machine communicate unit sends a machine return signal to the first machine according to the authentication success signal.

2. The machine setting device of claim 1, wherein the storage unit further stores composite machine setting data related to a setting information of a plurality of predetermined machines, and the machine communicate unit generates the machine return signal according to the composite machine setting data.

3. The machine setting device of claim 2, wherein the machine communicate unit is further connected to a second machine and receives a second machine signal of the second machine, and the processor generates the composite machine setting data according to the second machine signal for the first machine accessing the data of the second machine.

4. The machine setting device of claim 3, wherein the signal transform unit transforms the second machine signal to a normal format according to the normal communicate interface.

5. The machine setting device of claim 3, wherein the first machine signal and the second machine signal have different communication protocols.

6. The machine setting device of claim 1, wherein the authentication data is provided by a remote platform system through a communication network.

7. The machine setting device of claim 1, further comprising a remote communicate unit connected to a remote platform system through a communication network for receiving a remote platform signal, wherein the processor generates the composite machine setting data according to the remote platform signal.

8. The machine setting device of claim 1, wherein the machine communicate unit sends a test signal to the first machine, the first machine sends a test response signal according to the test signal, and the machine communicate unit determines whether to accept the first machine signal of the first machine according the test response signal.

9. A machine setting system, comprising:
a first machine, outputting a first machine signal;
a composite machine authentication device connected to the first machine for receiving the first machine signal, authenticating the first machine according an authentication data and the first machine signal, generating an authentication success information if authentication is successful, and sending a first machine return signal to the first machine according to the authentication success information; and
a remote platform connected to the composite machine authentication device through a communication network, sending the authentication data to the composite machine authentication device.

10. The machine setting system of claim 9, wherein the composite machine authentication device further stores composite machine setting data related to a setting information of a plurality of predetermined machines, and generates the first machine return signal according to the composite machine setting data.

11. The machine setting system of claim 9, wherein the remote platform further sends a remote platform signal to the composite machine authentication device, and the composite machine authentication device generates the composite machine setting data according to the remote platform signal and generates the first machine return signal according to the composite machine setting data.

12. The machine setting system of claim 11, wherein the first machine has first machine setting data, and the composite machine authentication device receives the first machine setting data according to the remote platform signal and transfers the first machine setting data to the remote platform.

13. The machine setting system of claim 9, further comprising a second machine having second machine setting data, and the composite machine authentication device receives the second machine setting data according to the first machine signal and generates the first return signal according to the second machine setting data.

14. The machine setting system of claim 13, wherein the first machine signal and the second machine signal have different communication protocols.

15. A method for setting machines performed by an electronic device connected to a first machine, comprising:
receiving a first machine signal of the first machine;
transforming the first machine signal into a machine analysis signal with a normal format according to a normal communicate interface;
authenticating the first machine according to an authentication data and the machine analysis signal;
outputting an authentication success signal if authentication is successful; and
sending a first machine return signal to the first machine according to the authentication success signal.

16. The method of claim 15, wherein the electronic device is further connected to a second machine, and the method further comprises:
receiving a second machine signal from the second machine;
generating composite machine setting data related to the second machine according to the second machine signal, wherein the second machine signal is transformed to a normal format according to a normal communicate interface; and
generating the first machine return signal according to the composite machine setting data for the first machine to access the data of the second machine.

17. The method of claim 15, wherein the authentication data is provided by a remote platform through a communication network.

18. The method of claim 15, wherein the electronic device is further connected to a remote platform through a communication network, and the method further comprises:
receiving a remote platform signal of the remote platform;
generating composite machine setting data according to the remote platform signal; and
generating the first machine return signal according to the composite machine setting data.

19. The method of claim 18, wherein the first machine has first machine setting data, and the method further comprises:
receiving the first machine setting data according to the remote platform signal; and
sending the first machine setting data to the remote platform.

20. The method of claim 15, further comprising:
sending a test signal to the first machine; and
determining whether to accept the first machine signal according a test response signal from the first machine
